(19) United States
(12) Patent Application Publication
(10) Pub. No.: US 2017/0046177 A1
(43) Pub. Date: Feb. 16, 2017

(54) SCREEN GENERATING APPARATUS

(71) Applicant: AZBIL CORPORATION, Chiyoda-ku (JP)

(72) Inventor: Kosuke YAMASHITA, Chiyoda-ku (JP)

(73) Assignee: AZBIL CORPORATION, Chiyoda-ku (JP)

(21) Appl. No.: 15/235,336

(22) Filed: Aug. 12, 2016

(30) Foreign Application Priority Data
Aug. 12, 2015 (JP) 2015-159471

(51) Int. Cl. G06F 9/44; G06F 3/0484; G09G 5/373

(52) U.S. Cl. CPC G06F 9/4443; G09G 5/373; G06F 3/04847; G09G 2340/045; G09G 2320/08; G09G 2354/00

(57) ABSTRACT

A screen generating apparatus includes an operation history recording unit that records an operation count by a user for a certain time period on a display screen for each operation button, a comparison unit that compares the operation count for each operation button with a first threshold value and a second threshold value, a non-display target setting unit that sets the operation button having an operation count lower than or equal to the first threshold value as a non-display target, and an enlargement target setting unit that sets the operation button having an operation count higher than or equal to the second threshold value as an enlargement target. The screen generating unit does not display any operation button set as the non-display target on the display screen and displays any operation button set as the enlargement target in a size larger than a standard size on the display screen.

### CROSS-REFERENCE TO RELATED APPLICATIONS

The present application claims priority to Japanese Application No. 2015-159471, filed Aug. 12, 2015, the entire contents of which are incorporated herein by reference.

### FIELD

The disclosure relates to a screen generating apparatus that generates a display screen using an operation history.

### DESCRIPTION OF THE RELATED ART

Building monitoring services are performed by users who monitor air conditioning control, environment management, safety management, and facilities management in buildings. Users ordinarily operate central monitoring apparatuses in building management rooms to confirm the states of facility equipment and so on (setting values, start and stop of the facility equipment) displayed in display apparatuses (for example, refer to Japanese Unexamined Patent Application Publication No. 08-110991).

The contents of the building monitoring services are varied for each building depending on the operation of the building. However, in the apparatus disclosed in Japanese Unexamined Patent Application Publication No. 08-110991, the layout on the display screen is determined in development of each product. Accordingly, there is a problem in that each user is forced to operate the same display screen and to perform the same operation.

In contrast, apparatuses are also known in which operation buttons less likely to be used are displayed in sizes smaller than standard sizes and operation buttons likely to be used are displayed in the standard sizes on display screens (for example, refer to Japanese Unexamined Patent Application Publication No. 2010-171903). However, with the method disclosed in Japanese Unexamined Patent Application Publication No. 2010-171903, there is a problem in that the operation buttons less likely to be used are only displayed in smaller sizes and erroneous operations may occur.

Accordingly, it is an object of the disclosure to provide a screen generating apparatus capable of changing the layout on the display screen depending on the operation history and capable of reducing erroneous operations, compared with configurations in related art.

### SUMMARY

The disclosure provides a screen generating apparatus including a screen generating unit, an operation history recording unit, a comparison unit, a non-display target setting unit, and an enlargement target setting unit. The screen generating unit generates a display screen including multiple operation buttons. The operation history recording unit records an operation count by a user for a certain time period on the display screen for each operation button. The comparison unit compares the operation count for each operation button, recorded in the operation history recording unit, with a first threshold value and a second threshold value higher than the first threshold value. The non-display target setting unit sets the operation button determined by the comparison unit to have an operation count lower than or equal to the first threshold value as a non-display target. The enlargement target setting unit sets the operation button determined by the comparison unit to have an operation count higher than or equal to the second threshold value as an enlargement target. The screen generating unit does not display any operation button set by the non-display target setting unit as the non-display target on the display screen and displays any operation button set by the enlargement target setting unit as the enlargement target in a size larger than a standard size on the display screen.

According to the disclosure, it is possible to change the layout on the display screen depending on the operation history and to reduce erroneous operations, compared with configurations in the related art.

### BRIEF DESCRIPTION OF THE DRAWINGS

FIG. 1 is a block diagram illustrating an exemplary configuration of a screen generating apparatus according to a first embodiment of the disclosure;

FIG. 2 illustrates an exemplary hardware configuration of the screen generating apparatus according to the first embodiment of the disclosure;

FIG. 3 is a flowchart illustrating an exemplary operational process performed by the screen generating apparatus according to the first embodiment of the disclosure;

FIG. 4 illustrates an exemplary display screen (standard screen) generated by the screen generating apparatus according to the first embodiment of the disclosure;

FIG. 5 illustrates an exemplary operation history recorded in the screen generating apparatus according to the first embodiment of the disclosure; and

FIG. 6 illustrates an exemplary display screen (updated screen) generated by the screen generating apparatus according to the first embodiment of the disclosure.

### DETAILED DESCRIPTION

Embodiments of the disclosure will herein be described in detail with reference to the attached drawings.

### First Embodiment

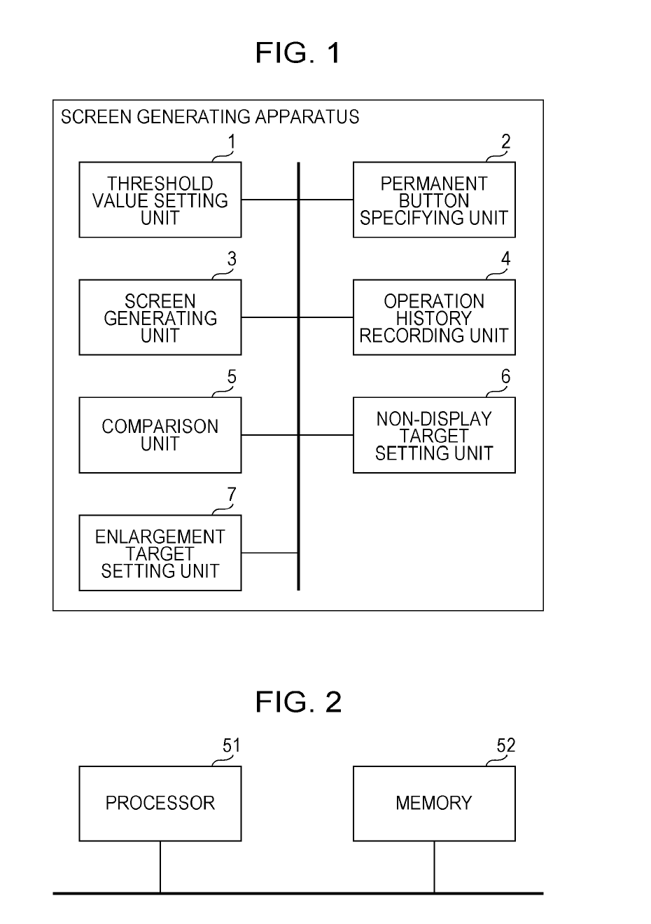

FIG. 1 is a block diagram illustrating an exemplary configuration of a screen generating apparatus according to a first embodiment of the disclosure.

Referring to FIG. 1, the screen generating apparatus includes a threshold value setting unit 1, a permanent button specifying unit 2, a screen generating unit 3, an operation history recording unit 4, a comparison unit 5, a non-display target setting unit 6, and an enlargement target setting unit 7.

The threshold value setting unit 1 sets threshold values used to determine whether the layout of operation buttons displayed on a display screen is to be changed. The threshold value setting unit 1 sets a first threshold value used to determine whether an operation button is not to be displayed and a second threshold value used to determine whether an operation button is to be displayed in a size larger than a standard size. The second threshold value is higher than the first threshold value. The threshold value setting unit 1 may set predetermined values as the first and second threshold values or may set the first and second threshold values in response to a user's operation.

The permanent button specifying unit 2 specifies an operation button (operation buttons) that is (are) constantly displayed, among the operation buttons displayed on the display screen, as a permanent button (permanent buttons). The permanent button specifying unit 2 may specify a predetermined operation button as the permanent button or may specify the permanent button in response to a user's operation. The permanent button specifying unit 2 may not necessarily be provided in the screen generating apparatus and may be removed from the screen generating apparatus.

The screen generating unit 3 generates the display screen including the multiple operation buttons. The screen generating unit 3 initially generates a standard display screen that is set in advance.

When information indicating the change of the layout is supplied from the non-display target setting unit 6 or the enlargement target setting unit 7, the screen generating unit 3 generates the display screen in accordance with the change of the layout. Specifically, when any operation button set by the non-display target setting unit 6 as a non-display target exists, the screen generating unit 3 does not display the operation button on the display screen. When any operation set by the enlargement target setting unit 7 as an enlargement target exists, the screen generating unit 3 displays the operation button in a size larger than the standard size on the display screen.

The display screen generated by the screen generating unit 3 is displayed on a display of a display apparatus (not illustrated).

The operation history recording unit 4 records an operation count by a user for a certain time period on the display screen that is generated by the screen generating unit 3 and that is displayed on the display of the display apparatus as an operation history for each operation button.

The comparison unit 5 compares the operation count recorded in the operation history recording unit 4 with the first threshold value and the second threshold value set by the threshold value setting unit 1 for each operation button.

The non-display target setting unit 6 sets the operation button determined by the comparison unit 5 to have an operation count lower than or equal to the first threshold value as the non-display target. The non-display target setting unit 6 does not set the operation button specified by the permanent button specifying unit 2 as the permanent button as the non-display target. Information indicating the operation button set by the non-display target setting unit 6 as the non-display target (information indicating the change of the layout) is supplied to the screen generating unit 3.

The enlargement target setting unit 7 sets the operation button determined by the comparison unit 5 to have an operation count higher than or equal to the second threshold value as the enlargement target. Information indicating the operation button set by the enlargement target setting unit 7 as the enlargement target (information indicating the change of the layout) is supplied to the screen generating unit 3.

An exemplary hardware configuration for realizing the screen generating apparatus having the above configuration will now be described with reference to FIG. 2.

The hardware configuration of the screen generating apparatus includes, for example, a processor 51 and a memory 52, as illustrated in FIG. 2.

Referring to FIG. 2, the operation history recording unit 4 illustrated in FIG. 1 is realized by the memory 52. The threshold value setting unit 1, the permanent button specifying unit 2, the screen generating unit 3, the comparison unit 5, the non-display target setting unit 6, and the enlargement target setting unit 7 illustrated in FIG. 1 are realized by the processor 51 that executes programs recorded in the memory 52. Multiple processors 51 and multiple memories 52 may perform the above functions in cooperation with each other.

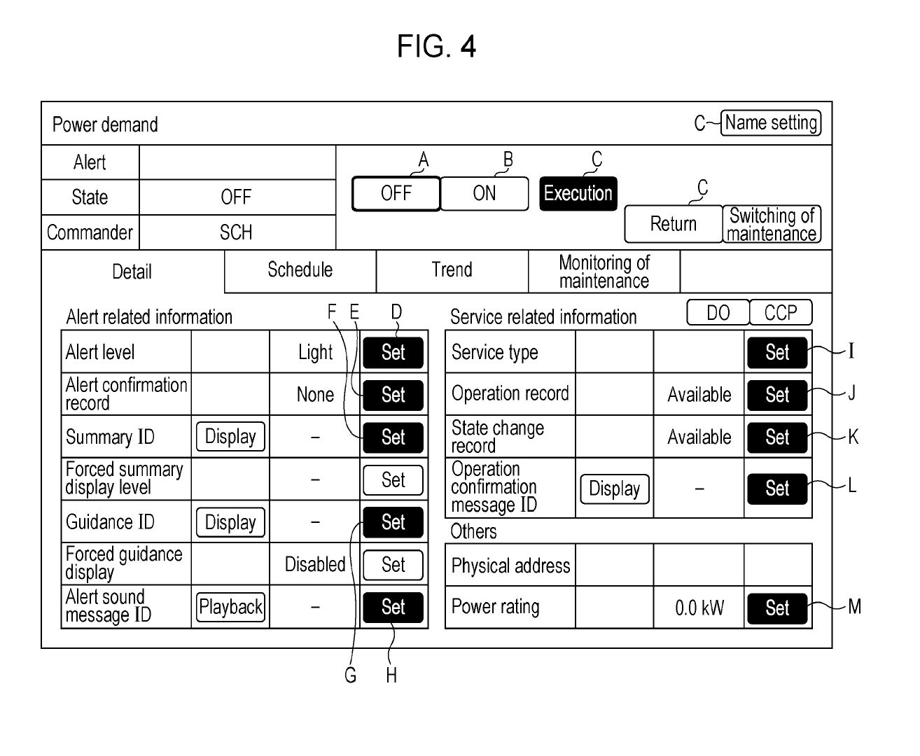

An exemplary operation of the screen generating apparatus having the above configuration will now be described. The threshold value setting unit 1 sets the threshold values (the first threshold value and the second threshold value) used to determine whether the layout of the operation buttons displayed on the display screen is to be changed. The permanent button specifying unit 2 specifies the operation buttons that are constantly displayed, among the operation buttons displayed on the display screen, as the permanent buttons. In a display screen illustrated in FIG. 4, C buttons (an Execution button, a Name setting button, and a Return button) are the permanent buttons.

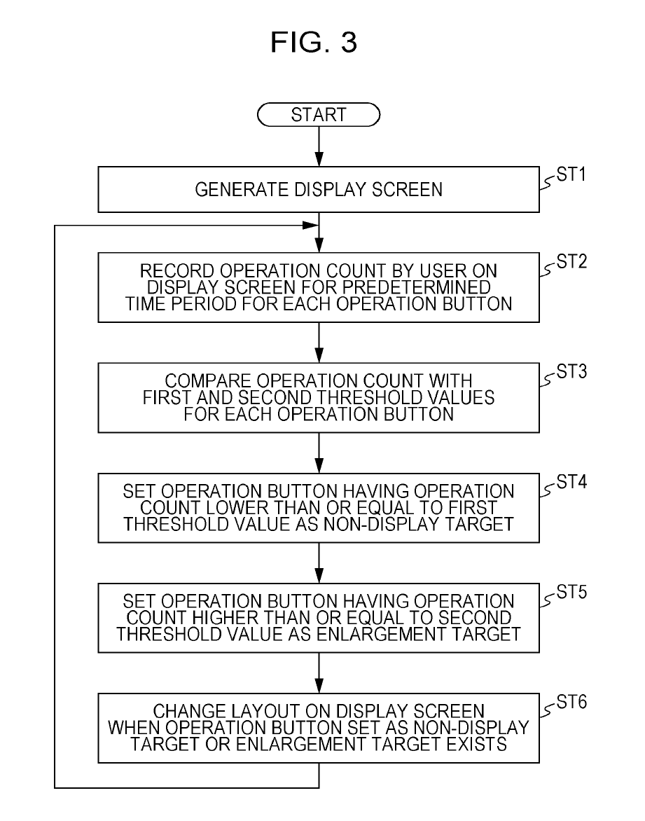

FIG. 3 is a flowchart illustrating an exemplary operational process performed by the screen generating apparatus. Referring to FIG. 3, in Step ST1, the screen generating unit 3 generates the display screen including the multiple operation buttons. The screen generating unit 3 initially generates, for example, the standard display screen illustrated in FIG. 4. The display screen generated by the screen generating unit 3 is displayed on the display of the display apparatus (not illustrated).

The user operates the display screen displayed in the display to perform various operations including confirmation of detailed settings, confirmation of the operation schedule of facility equipment, and confirmation of a trend graph. In the display screen illustrated in FIG. 4, operation buttons to which alphabets A to M are added are the operation buttons to be subjected to the change of the layout.

In Step ST2, the operation history recording unit 4 records the operation count by the user for a certain time period on the display screen that is generated by the screen generating unit 3 and that is displayed on the display of the display apparatus as the operation history for each operation button.

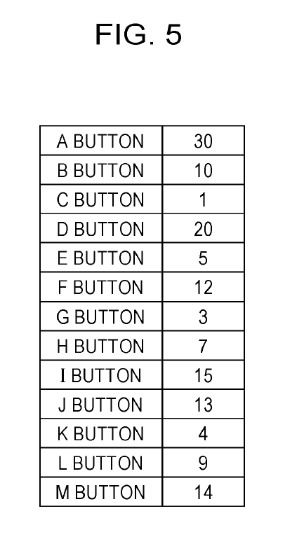

FIG. 5 illustrates an example of the operation history recorded in the operation history recording unit 4. For example, when the user clicks the A button (OFF button) on the display screen in FIG. 4, the operation history recording unit 4 counts “+1” as the operation count for the A button. The operation history is updated for each operation (click) by the user.

In Step ST3, after the certain time period, the comparison unit 5 compares the operation count recorded in the operation history recording unit 4 with the first threshold value and the second threshold value set by the threshold value setting unit 1 for each operation button.

In Step ST4, the non-display target setting unit 6 sets the operation button determined by the comparison unit 5 to have an operation count lower than or equal to the first threshold value as the non-display target. The non-display target setting unit 6 does not set the operation button specified by the permanent button specifying unit 2 as the permanent button as the non-display target. The information indicating the operation button set by the non-display target setting unit 6 as the non-display target (the information indicating the change of the layout) is supplied to the screen generating unit 3.

In Step ST5, the enlargement target setting unit 7 sets the operation button determined by the comparison unit 5 to have an operation count higher than or equal to the second threshold value as the enlargement target. The information indicating the operation button set by the enlargement target setting unit 7 as the enlargement target (the information indicating the change of the layout) is supplied to the screen generating unit 3.

Although the processing by the non-display target setting unit 6 and the processing by the enlargement target setting unit 7 are described in this order in the flowchart illustrated in FIG. 3, the processing order may be reversed or the processing by the non-display target setting unit 6 may be performed concurrently with the processing by the enlargement target setting unit 7.

When the information indicating the change of the layout is supplied from the non-display target setting unit 6 or the enlargement target setting unit 7, in Step ST6, the screen generating unit 3 changes the layout on the display screen in accordance with the information. Specifically, when any operation button set by the non-display target setting unit 6 as the non-display target exists, the screen generating unit 3 does not display the operation button on the display screen. When any operation button set by the enlargement target setting unit 7 as the enlargement target exists, the screen generating unit 3 displays the operation button in a size larger than the standard size on the display screen. The display screen the layout on which is changed by the screen generating unit 3 is displayed on the display of the display apparatus (not illustrated).

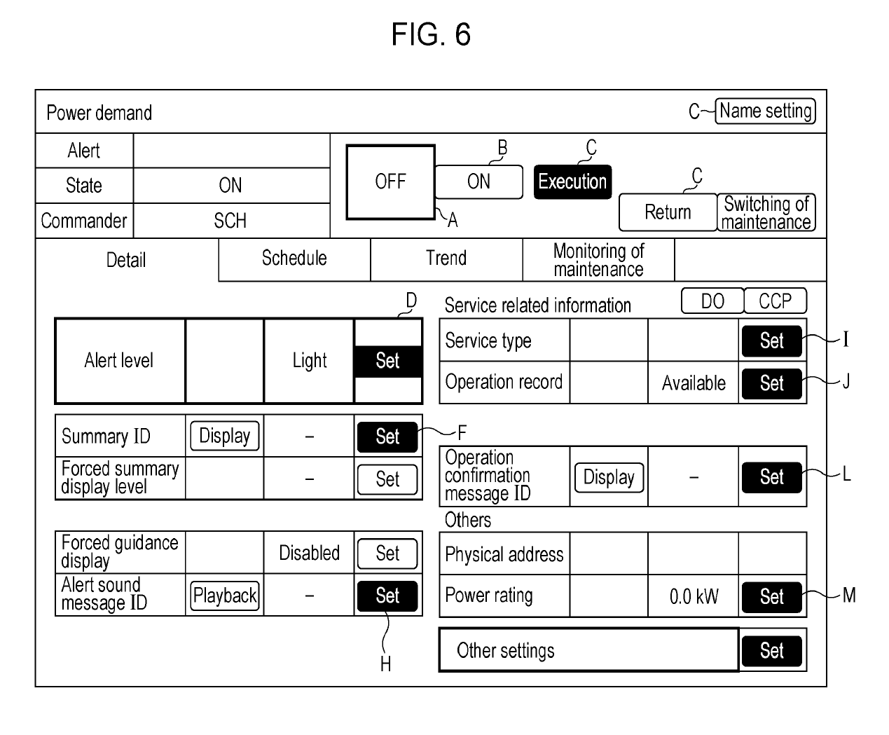

FIG. 6 illustrates an exemplary display screen resulting from updating of the display screen illustrated in FIG. 4 based on the operation history illustrated in FIG. 5. In the display screen illustrated in FIG. 6, the first threshold value is set to five and the operation button having an operation count of five or less for a certain time period is not displayed. The second threshold value is set to 20 and the operation button having an operation count of 20 or more for a certain time period is displayed in a size larger than the standard size. The C buttons are set as the permanent buttons.

In the example illustrated in FIG. 5, the operation counts of the C button, the E button, the C button, and the K button are lower than or equal to the first threshold value (five). Accordingly, the non-display target setting unit 6 sets the E button, the G button, and the K button as the non-display targets. Since the C button is set as the permanent button, the C button is not set as the non-display target even when the C button has an operation count lower than or equal to the first threshold value.

In the example illustrated in FIG. 5, the operation counts of the A button and the D button are higher than or equal to the second threshold value (20). Accordingly, the enlargement target setting unit 7 sets the A button and the D button as the enlargement targets.

The screen generating unit 3 does not display the E button, the G button, and the K button and displays the A button and the D button in sizes larger than the standard size, as on the display screen illustrated in FIG. 6.

On the display screen illustrated in FIG. 6, when the user wants to operate the operation button that is not displayed, for example, the user clicks an “Other settings” button that is newly displayed at a lower right portion in FIG. 6. This operation allows the user to operate the operation button that is not displayed.

Alternatively, the operation button that is not displayed may be set to a disabled state until the operation button that is not displayed is specified as the permanent button or until the operational process by the screen generating apparatus is performed again from Step ST1 without providing the “Other settings” button illustrated in FIG. 6.

How to handle the operation button that is not displayed (whether the operation button is enabled with the “Other settings” button or is disabled) may be determined by the setting in the non-display target setting unit 6.

The change of the layout on the display screen is performed every predetermined time period (for example, every one month). Whether the layout on the display screen is to be changed may be determined by the user.

The operation histories of the operation buttons that are set as the permanent buttons may not be recorded in the operation history recording unit 4.

As described above, according to the first embodiment, the screen generating apparatus includes the operation history recording unit 4, the comparison unit 5, the non-display target setting unit 6, and the enlargement target setting unit 7. The operation history recording unit 4 records the operation count by the user for a certain time period on the display screen for each operation button. The comparison unit 5 compares the operation count for each operation button, recorded in the operation history recording unit 4, with the first threshold value and the second threshold value higher than the first threshold value. The non-display target setting unit 6 sets the operation button determined by the comparison unit 5 to have an operation count lower than or equal to the first threshold value as the non-display target. The enlargement target setting unit 7 sets the operation button determined by the comparison unit 5 to have an operation count higher than or equal to the second threshold value as the enlargement target. Since the screen generating unit 3 is configured so that the screen generating unit 3 does not display any operation button set by the non-display target setting unit 6 as the non-display target on the display screen and displays any operation button set by the enlargement target setting unit 7 as the enlargement target in a size larger than the standard size on the display screen, it is possible to change the layout on the display screen in accordance with the operation history and to reduce erroneous operations, compared with configurations in the related art. In other words, causing the operation button having a lower operation frequency not to be displayed allows erroneous operations to be reduced, thereby providing the user-friendliness display screen.

Arbitrary components of the embodiment may be modified or omitted without departing from the true spirit and scope of the disclosure.

What is claimed is:

1. A screen generating apparatus comprising:
a screen generating unit configured to generate a display screen including a plurality of operation buttons;
an operation history recording unit configured to record an operation count by a user for a certain time period on the display screen for each operation button;
a comparison unit configured to compare the operation count for each operation button, recorded in the operation history recording unit, with a first threshold value and a second threshold value higher than the first threshold value;
a non-display target setting unit configured to set the operation button determined by the comparison unit to have an operation count lower than or equal to the first threshold value as a non-display target; and
an enlargement target setting unit configured to set the operation button determined by the comparison unit to have an operation count higher than or equal to the second threshold value as an enlargement target,
wherein the screen generating unit does not display any operation button set by the non-display target setting unit as the non-display target on the display screen and displays any operation button set by the enlargement target setting unit as the enlargement target in a size larger than a standard size on the display screen.

2. The screen generating apparatus according to claim 1, further comprising:
a permanent button specifying unit configured to specify the operation button that is constantly displayed on the display screen,
wherein the non-display target setting unit does not set the operation button specified by the permanent button specifying unit as the non-display target.
